(19) United States
(12) Patent Application Publication
(10) Pub. No.: US 2025/0295557 A1
(43) Pub. Date: Sep. 25, 2025

(54) DUSTPROOF NASAL IRRIGATOR

(71) Applicant: Medcodes Healthcare (Shenzhen) Limited, Shenzhen (CN)

(72) Inventors: Shengqiang DAI, Shenzhen (CN); Chuanzhou ZHENG, Shenzhen (CN); Dongbao LI, Shenzhen (CN)

(73) Assignee: Medcodes Healthcare (Shenzhen) Limited, Shenzhen (CN)

(21) Appl. No.: 18/816,286

(22) Filed: Aug. 27, 2024

(30) Foreign Application Priority Data
Mar. 20, 2024 (CN) 202420551228.9

(51) Int. Cl. A61H 35/04

(52) U.S. Cl. CPC A61H 35/04; A61H 2201/01; A61H 2205/023

(57) ABSTRACT

A dustproof nasal irrigator includes a nozzle assembly and a shielding cover. The nozzle assembly includes a nozzle seat, a raw liquid nozzle and a waste liquid nozzle, the raw liquid nozzle and the waste liquid nozzle are both connected to the nozzle seat, the shielding cover is detachably connected to the nozzle seat, a receiving cavity is provided in the shielding cover, and when the shielding cover is connected to the nozzle seat, the raw liquid nozzle and the waste liquid nozzle are both located in the receiving cavity.

### CROSS-REFERENCE TO RELATED APPLICATIONS

This application claims priority to Chinese Patent Application No. 202420551228.9, filed on Mar. 20, 2024, the entire contents of which are incorporated herein by reference.

### TECHNICAL FIELD

The present application relates to the technical field of nasal irrigators, and in particular to a dustproof nasal irrigator.

### BACKGROUND

A nasal irrigator is a tool for cleaning the nasal cavity, which directs the liquid in the water tank into the nozzle through the water pump. The liquid is fed by the nozzle into one nostril, flows through the nasal vestibule, sinuses, nasal passages, bypasses the nasopharynx, and then is discharged from the other nostril, or discharged from the mouth. Through the above path, with the help of the impact force of the saline water flow, the pathogens and pollutants that have accumulated in the nasal cavity are discharged, so that the nasal cavity can restore its normal physiological environment, restore the self-detoxification function of the nasal cavity, thereby protecting the nasal cavity.

At present, no dust-proof measures are taken on the nozzle of the nasal irrigator. Thus, the nozzle is exposed to the air, which makes the nozzle easily contaminated with dust or other dirt when not used for a long time.

### SUMMARY

The main purpose of the present application is to provide a dustproof nasal irrigator, aiming to solve the problem that no dustproof measures are taken on the existing nozzle.

To achieve the above purpose, the present application provides a dustproof nasal irrigator, including: a nozzle assembly and a shielding cover.

In an embodiment, the nozzle assembly includes a nozzle seat, a raw liquid nozzle and a waste liquid nozzle, the raw liquid nozzle and the waste liquid nozzle are both connected to the nozzle seat.

In an embodiment, the shielding cover is detachably connected to the nozzle seat, a receiving cavity is provided in the shielding cover, and when the shielding cover is connected to the nozzle seat, the raw liquid nozzle and the waste liquid nozzle are both provided in the receiving cavity.

In an embodiment, the nozzle seat is provided with a first clamping portion, the shielding cover is provided with a second clamping portion, and the first clamping portion is clamped with the second clamping portion to connect the shielding cover to the nozzle seat.

In an embodiment, the first clamping portion includes a clamping groove, and the second clamping portion includes a clamping protrusion, the clamping protrusion is provided in the receiving cavity, and the clamping protrusion is clamped in the clamping groove.

In an embodiment, the dustproof nasal irrigator further includes a raw liquid tank and a waste liquid tank, the raw liquid tank is communicated with the raw liquid nozzle, the waste liquid tank is communicated with the waste liquid nozzle, the raw liquid tank is configured to store the cleaning liquid, and the waste liquid tank is configured to recover the cleaning liquid.

In an embodiment, the dust-proof nasal irrigator further includes a pipeline assembly provided with a raw liquid tube and a waste liquid tube, the nozzle seat is provided with a raw liquid port communicated with the raw liquid nozzle and a waste liquid port communicated with the waste liquid nozzle, one end of the raw liquid tube is communicated with the raw liquid tank, another end of the raw liquid tube is communicated with the raw liquid port, one end of the waste liquid tube is communicated with the waste liquid tank, and another end of the waste liquid tube is communicated with the waste liquid port.

In an embodiment, the pipeline assembly further includes a fixing member, one end of the fixing member is communicated with the raw liquid tube, another end of the fixing member is communicated with the raw liquid tank, and the raw liquid tube is fixed to the raw liquid tank through the fixing member.

In an embodiment, the pipeline assembly further includes a circulating air pipe, the raw liquid tank is communicated with the waste liquid tank through the circulating air pipe, and an air pressure in the raw liquid tank is identical to an air pressure in the waste liquid tank.

In an embodiment, the raw liquid nozzle is inclined at an angle toward a direction close to the waste liquid nozzle, and the waste liquid nozzle is inclined at the same angle toward a direction close to the raw liquid nozzle.

In an embodiment, the raw liquid nozzle and/or the waste liquid nozzle are detachably connected to the nozzle seat.

In an embodiment, the shielding cover is provided with a vent hole communicated with the receiving cavity.

In the technical solution of the present application, the shielding cover is detachably connected to the nozzle seat. When the shielding cover is connected to the nozzle seat, the raw liquid nozzle and the waste liquid nozzle are provided in the receiving cavity of the shielding cover, and the raw liquid nozzle and the waste liquid nozzle are isolated from the external environment, thereby achieving the purpose of preventing the raw liquid nozzle and the waste liquid nozzle from being contaminated by dust when the nasal irrigator is not used for a long time.

### BRIEF DESCRIPTION OF THE DRAWINGS

In order to more clearly illustrate the embodiments of the present application or the technical solutions in the related art, the drawings required for use in the embodiments or the description of the prior art will be briefly introduced below. Obviously, the drawings described below are only some embodiments of the present application. For ordinary technicians in this field, other drawings can be obtained based on the structures shown in these drawings without creative work.

FIG. 1 is a schematic structural view of a dustproof nasal irrigator according to an embodiment of the present application.

FIG. 2 is a schematic structural view of the dustproof nasal irrigator according to an embodiment of the present application.

FIG. 3 is a schematic structural view of a shielding cover.

FIG. 4 is a schematic structural view of the dustproof nasal irrigator according to another embodiment of the present application.

FIG. 5 is a schematic structural view of a fixing member.

The realization of the objective, functional characteristics, and advantages of the present application are further described with reference to the accompanying drawings.

### DETAILED DESCRIPTION OF THE EMBODIMENTS

The technical solutions in the embodiments of the present application will be clearly and completely described below with reference to the drawings in the embodiment of the present application. Obviously, the described embodiments are only a part of the embodiments of the present application, not all of the embodiments. Based on the embodiments in the present application, all other embodiments perceived by those ordinary skills in the art without creative effort should be fallen within the protection scope of the present application.

It should be noted that all of the directional instructions in the embodiments of the present application (such as, up, down, left, right, front, rear . . . ) are only used to explain the relative position relationship and movement of each component under a specific attitude (as shown in the drawings), if the specific attitude changes, the directional instructions will change correspondingly.

Besides, the descriptions in the present application that refer to “first”, “second”, etc. are only for descriptive purposes and are not to be interpreted as indicating or implying relative importance or to implicitly indicate the number of technical features indicated. In addition, technical solutions between the embodiments can be combined with each other, but must be based on the realization of the technical solutions by those skilled in the art, and when the technical solutions are contradictory to each other or cannot be realized, the technical solutions should be considered that the combination does not exist, and the technical solutions are not fallen within the protection scope claimed in the present application.

A nasal irrigator is a tool for cleaning the nasal cavity, which directs the liquid in the water tank into the nozzle through the water pump. The liquid is fed by the nozzle into one nostril, flows through the nasal vestibule, sinuses, nasal passages, bypasses the nasopharynx, and then is discharged from the other nostril, or discharged from the mouth. Through the above path, with the help of the impact force of the saline water flow, the pathogens and pollutants that have accumulated in the nasal cavity are discharged, so that the nasal cavity can restore its normal physiological environment, restore the self-detoxification function of the nasal cavity, thereby protecting the nasal cavity.

At present, no dust-proof measures are taken on the nozzle of the nasal irrigator. Thus, the nozzle is exposed to the air, which makes the nozzle easily contaminated with dust or other dirt when not used for a long time.

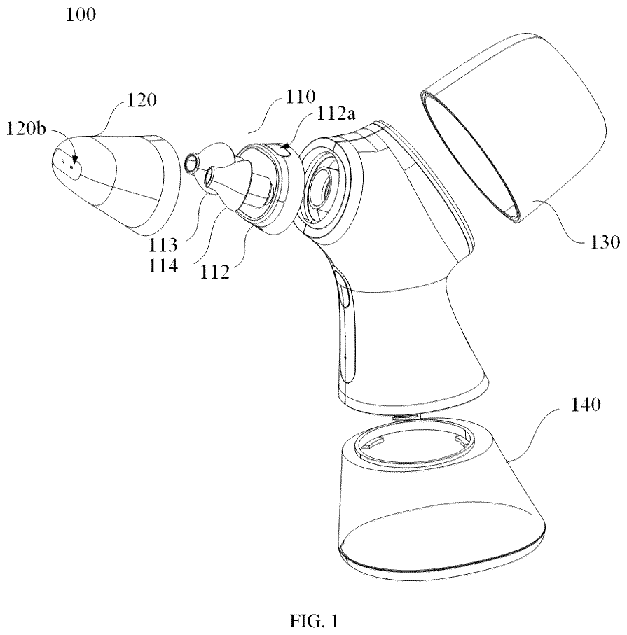

To solve the above problem, as shown in FIG. 1 to FIG. 4, the present application provides a dustproof nasal irrigator 100, including: a nozzle assembly 110 and a shielding cover 12.

The nozzle assembly 110 includes a nozzle seat 112, a raw liquid nozzle 113 and a waste liquid nozzle 114, and the raw liquid nozzle 113 and the waste liquid nozzle 114 are both connected to the nozzle seat.

The shielding cover 12 is detachably connected to the nozzle seat 112, a receiving cavity is provided in the shielding cover 12, and when the shielding cover 12 is connected to the nozzle seat 112, the raw liquid nozzle 113 and the waste liquid nozzle 114 are both provided in the receiving cavity.

In an embodiment, the shielding cover 120 is detachably connected to the nozzle seat 112. When the shielding cover 120 is connected to the nozzle seat 112, the raw liquid nozzle 113 and the waste liquid nozzle 114 are provided in the receiving cavity 120a of the shielding cover 120, and the raw liquid nozzle 113 and the waste liquid nozzle 114 are isolated from the external environment, thereby achieving the purpose of preventing the raw liquid nozzle 113 and the waste liquid nozzle 114 from being contaminated by dust when the nasal irrigator 100 is not used for a long time.

It should be noted that the raw liquid nozzle 113 and the waste liquid nozzle 114 are provided at the same side of the nozzle seat 112, and are connected to the body of the nasal irrigator 100 through the nozzle holder 112. When in use, if the raw liquid nozzle 113 is inserted into the first nostril, the waste liquid nozzle 114 will be inserted into the second nostril of the user, if the raw liquid nozzle 113 is inserted into the second nostril, the waste liquid nozzle 114 will be inserted into the first nostril of the user, and the cleaning liquid enters the first nostril of the user from the raw liquid nozzle 113, and flows through the nasal vestibule, sinuses, nasal passages, bypasses the nasopharynx, and then discharged from the waste liquid nozzle 114 of the second nostril of the user.

The raw liquid nozzle 113 and the waste liquid nozzle 114 are both made of silicone material, the soft silicone material can reduce the discomfort caused by the nozzle to the user and improve the user's experience of using the nasal irrigator 100.

In an embodiment, as shown in FIG. 1, the nozzle seat 112 is provided with a first clamping portion, and the shielding cover 120 is provided with a second clamping portion. The first clamping portion is clamped with the second clamping portion, and the shielding cover 120 is connected to the nozzle holder 112.

In an embodiment, the shielding cover 120 is snap-fitted with the nozzle seat 112 to achieve quick disassembly and quick assembly of the shielding cover 120. In other embodiments, an internal thread may be provided in the shielding cover 120, and an external thread may be provided in the nozzle seat 112, and the shielding cover 120 threadedly connected with the nozzle seat 112 to achieve the purpose of detachable connection between the shielding cover 120 and the nozzle holder 112, which is not limited here.

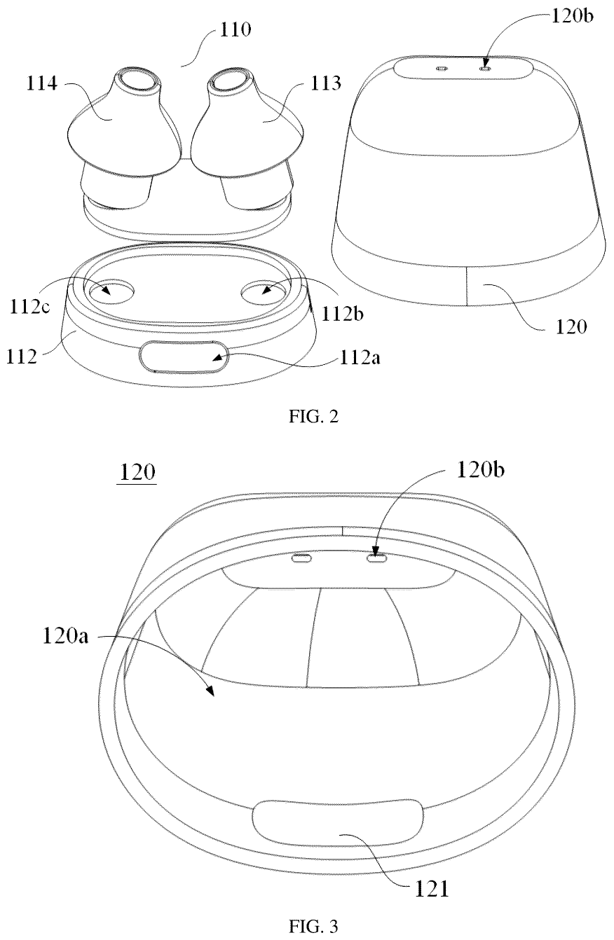

In an embodiment, as shown in FIG. 2 and FIG. 3, the first clamping portion includes a clamping groove 112a, and the second clamping portion includes a clamping protrusion 121. The clamping protrusion 121 is provided in the receiving cavity 120a, and the clamping protrusion 121 is clamped in the clamping groove 112a.

In an embodiment, the clamping protrusion 121 extends along the circumference of the shielding cover 120, and both ends of the clamping protrusion 121 are arc-shaped, that is, the clamping protrusion 121 is roughly elliptical. There are two clamping protrusions 121, and the two clamping protrusions 121 are relatively provided in the shielding cover 120. The shape of the clamping groove 112a matches the shape of the clamping protrusion 121. The two clamping protrusions 121 are relatively provided to ensure the connection stability between the shielding cover 120 and the nozzle seat 112.

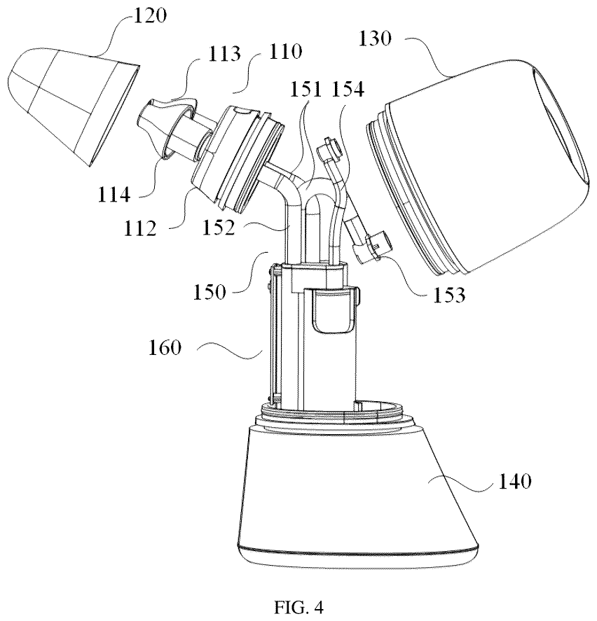

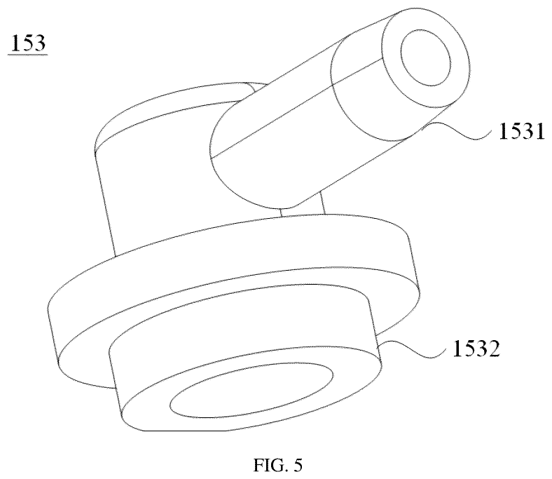

In an embodiment, as shown in FIG. 1 and FIG. 4, the dustproof nasal irrigator 100 further includes a raw liquid tank 130 and a waste liquid tank 140, the raw liquid tank 130 is communicated with the raw liquid nozzle 113, the waste liquid tank 130 is communicated with the waste liquid nozzle 114, the raw liquid tank 130 is configured to store the cleaning liquid, and the waste liquid tank 140 is configured to recover the cleaning liquid.

In an embodiment, in order to prevent the cleaning waste liquid from escaping after use, a waste liquid tank 140 is provided to collect the cleaning waste liquid. The cleaning waste liquid flows out from the waste liquid nozzle 114 into the waste liquid tank 140 to prevent the cleaning waste liquid from flowing into the external environment. When the user uses the nasal irrigator 100, other parts of the body except the nasal cavity will not be exposed to the cleaning liquid, and the user's satisfaction will be improved.

In an embodiment, as shown in FIG. 4, the dust-proof nasal irrigator 100 further includes a pipeline assembly 150 provided with a raw liquid tube 151 and a waste liquid tube 152. The nozzle seat 112 is provided with a raw liquid port 1132 communicated with the raw liquid nozzle 113 and a waste liquid port 112c communicated with the waste liquid nozzle 114. One end of the raw liquid tube 151 is communicated with the raw liquid tank 130, and another end of the raw liquid tube 151 is communicated with the raw liquid port 1132. One end of the waste liquid tube 152 is communicated with the waste liquid tank 140, and another end of the waste liquid tube 152 is communicated with the waste liquid port 112c.

The dustproof nasal irrigator 100 further includes a motor assembly 160, and the motor assembly 160 includes a water pump. The cleaning liquid in the raw liquid tank 130 is pumped into the raw liquid nozzle 113 through the water pump.

In an embodiment, the pipeline assembly 150 further includes a fixing member 153, one end of the fixing member 153 is communicated with the raw liquid tube 151, another end of the fixing member 153 is communicated with the raw liquid tank 130, and the raw liquid tube 151 is fixed to the raw liquid tank 130 through the fixing member 153.

In an embodiment, the fixing member 153 includes a first fixing portion 1531 and a second fixing portion 1532. The outer diameter of the first fixing portion 1531 is smaller than the inner diameter of the raw liquid tube 151, and the raw liquid tube 151 can be sleeved on the outside of the first fixing portion 1531; the second fixing portion 1532 includes a clamping platform for clamping with the raw liquid tank 130. In addition, a fastener can also be provided. The fastener passes through the second fixing portion 1532 and the raw liquid tank 130 to fix the fixing member 153 to the raw liquid tank 130. The fixing member 153 communicates and fixes the raw liquid tube 151 with the raw liquid tank 130 to prevent the raw liquid tube 151 from falling off from the raw liquid tank 130 when transporting the cleaning liquid, thereby improving the stability of the use of the dust-proof nasal irrigator.

In other embodiments, the waste liquid tube 152 may also be provided with the same fixing member 153 to achieve the same effect.

In an embodiment, the pipeline assembly 150 further includes a circulating air pipe 154, the raw liquid tank 130 and the waste liquid tank 140 are communicated through the circulating air pipe 154, and an air pressure in the raw liquid tank 130 is identical to an air pressure in the waste liquid tank 140.

In an embodiment, Since the volume of the cleaning liquid in the original liquid tank 130 will decrease as the nasal irrigator 100 is used, while the volume of the gas in the original liquid tank 130 will increase, resulting in a decrease in pressure, similarly, the volume of the cleaning liquid in the waste liquid tank 140 will continue to increase as the nasal irrigator 100 is used, the volume of its gas will continue to decrease, and the pressure will increase. The pressure difference between the raw liquid tank 130 and the waste liquid tank 140 makes it difficult for the cleaning liquid to flow from the raw liquid tank 130 to the waste liquid tank 140. Therefore, a circulating air pipe 154 is provided to communicate the original liquid tank 130 and the waste liquid tank 140, and the air pressure between the two is equal, thereby ensuring the normal use of the nasal irrigator 100.

It should be noted that in order to prevent the cleaning liquid in the raw liquid tank 130 from directly flowing into the waste liquid tank 140 through the circulating air pipe 154, the circulating air pipe 154 is provided over to the top of the liquid level when the raw liquid tank 130 is fully loaded.

In an embodiment, as shown in FIG. 2, the raw liquid nozzle 113 is inclined at an angle toward a direction close to the waste liquid nozzle 114, and the waste liquid nozzle 114 is inclined at the same angle toward a direction close to the raw liquid nozzle 113.

In an embodiment, the raw liquid nozzle 113 and the waste liquid nozzle 114 are inclined toward each other at an angle, which is convenient for the user to insert the nozzle into the nostril, the incline angle is between 15° and 30°.

In an embodiment, as shown in FIG. 2, the raw liquid nozzle 113 and/or the waste liquid nozzle 114 are detachably connected to the nozzle seat 112.

In an embodiment, the raw liquid nozzle 113 and/or the waste liquid nozzle 114 are detachably connected to the nozzle seat 112, and the user can replace the nozzle according to the size of his or her own nasal cavity.

In an embodiment, as shown in FIG. 1 to FIG. 3, the shielding cover 120 is provided with a vent hole 120a communicated with the receiving cavity 120b.

In an embodiment, in order to prevent the residual liquid in the raw liquid nozzle 113 and/or the waste liquid nozzle 114 after use from being unable to evaporate, causing the raw liquid nozzle 113 and/or the waste liquid nozzle 114 to easily breed bacteria or stink, an vent hole 120b is provided at the end of the shielding cover 120 away from the nozzle seat 112. In order to accelerate the volatilization of the residual cleaning liquid at the nozzle, a multiple of vent holes 120b can be provided.

The above contents are only some embodiments of the present application, and do not limit the scope of the present application. All equivalent structural changes made by using the contents of the present application specification and drawings under the inventive concept of the present application, or directly/indirectly applied in other related technical fields are included in the scope of the present application.

What is claimed is:

1. A dustproof nasal irrigator, comprising:
a nozzle assembly; and
a shielding cover, wherein:
the nozzle assembly comprises a nozzle seat, a raw liquid nozzle and a waste liquid nozzle, the raw liquid nozzle and the waste liquid nozzle are both connected to the nozzle seat; and
the shielding cover is detachably connected to the nozzle seat, a receiving cavity is provided in the shielding cover, and when the shielding cover is connected to the nozzle seat, the raw liquid nozzle and the waste liquid nozzle are both provided in the receiving cavity.

2. The dustproof nasal irrigator of claim 1, wherein the nozzle seat is provided with a first clamping portion, the shielding cover is provided with a second clamping portion, and the first clamping portion is clamped with the second clamping portion to connect the shielding cover to the nozzle seat.

3. The dustproof nasal irrigator of claim 2, wherein the first clamping portion comprises a clamping groove, the second clamping portion comprises a clamping protrusion, the clamping protrusion is provided in the receiving cavity, and the clamping protrusion is clamped in the clamping groove.

4. The dustproof nasal irrigator of claim 1, further comprising:
a raw liquid tank; and
a waste liquid tank, wherein:
the raw liquid tank is communicated with the raw liquid nozzle, the waste liquid tank is communicated with the waste liquid nozzle, the raw liquid tank is configured to store the cleaning liquid, and the waste liquid tank is configured to recover the cleaning liquid.

5. The dustproof nasal irrigator of claim 4, further comprising:
a pipeline assembly provided with a raw liquid tube and a waste liquid tube, wherein:
the nozzle seat is provided with a raw liquid port communicated with the raw liquid nozzle and a waste liquid port communicated with the waste liquid nozzle, one end of the raw liquid tube is communicated with the raw liquid tank, another end of the raw liquid tube is communicated with the raw liquid port, one end of the waste liquid tube is communicated with the waste liquid tank, and another end of the waste liquid tube is communicated with the waste liquid port.

6. The dustproof nasal irrigator of claim 5, wherein the pipeline assembly further comprises a fixing member, one end of the fixing member is communicated with the raw liquid tube, another end of the fixing member is communicated with the raw liquid tank, and the raw liquid tube is fixed to the raw liquid tank through the fixing member.

7. The dustproof nasal irrigator of claim 5, wherein the pipeline assembly further comprises a circulating air pipe, the raw liquid tank is communicated with the waste liquid tank through the circulating air pipe, and an air pressure in the raw liquid tank is identical to an air pressure in the waste liquid tank.

8. The dustproof nasal irrigator of claim 4, wherein the raw liquid nozzle is inclined at an angle toward a direction close to the waste liquid nozzle, and the waste liquid nozzle is inclined at the same angle toward a direction close to the raw liquid nozzle.

9. The dustproof nasal irrigator of claim 1, wherein the raw liquid nozzle and/or the waste liquid nozzle are detachably connected to the nozzle seat.

10. The dustproof nasal irrigator of claim 1, wherein the shielding cover is provided with a vent hole communicated with the receiving cavity.
